(19) United States
(12) Patent Application Publication
(10) Pub. No.: US 2011/0113474 A1
(43) Pub. Date: May 12, 2011

(54) NETWORK SYSTEM SECURITY MANAGMENT

(75) Inventors: Uma M. Chandolu, Austin, TX (US); Yantian T. Lu, Round Rock, TX (US); Puneet Mahajan, Austin, TX (US); Ashish Nainwal, New Delhi (IN)

(73) Assignee: INTERNATIONAL BUSINESS MACHINES CORPORATION, Armonk, NY (US)

(21) Appl. No.: 12/616,266

(22) Filed: Nov. 11, 2009

(51) Int. Cl. G06F 21/20

(52) U.S. Cl. 726/4

(57) ABSTRACT

A network system loads operating system (OS) software that includes a switch role tool (SRT). The SRT provides the network system with security management capability that employs a hostname attribute within a user role definition. The user role definition provides for user restrictions to database information and other user actions within the network system. During a user login or switch role command, the security management method interrogates the login location or hostname of the login along with the user request. If that login meets the criteria that the network system stores as a user role attribute for that particular user, the network system allows the login request and action. If that login does not meet the criteria that the network system stores as a user role attribute for that user, the network system denies the login request. The network system grants the user an access privilege level that varies with the determined location or hostname from which the user attempts to login.

### BACKGROUND

The disclosures herein relate generally to network systems, and more specifically, to information handling systems (IHSs) that network systems employ.

Network systems employ information handling systems (IHSs) that process information or data. The IHS may manage communication between multiple IHSs, such as servers, hosts, etc. It is beneficial to manage the security of communications and actions within each IHS or between that of multiple IHSs of a network system.

### BRIEF SUMMARY

In one embodiment, a method is disclosed for granting access to secure information. The method includes storing, by a first information handing system (IHS), security information that associates a role with a particular user, the role designating a privilege level for the particular user that is dependent on a network login location from which the particular user attempts to login to the first IHS. The method also includes determining, by the first IHS, the particular network login location from which the particular user attempts to login to the first IHS, thus providing determined location information. The method further includes granting, by the first IHS, access to the first IHS to the particular user at a privilege level dependent on the determined location information for the particular user.

In another embodiment, an information handling system (IHS) is disclosed that secures information. The IHS includes a processor. The IHS also includes a memory that couples to the processor. The memory is configured to store security information that associates a role with a particular user, the role designating a privilege level for the particular user that is dependent on a network login location from which the particular user attempts to login to the IHS. The memory is also configured to determine the particular network login location from which the particular user attempts to login to the IHS, thus providing determined location information. The memory is further configured to grant access to the IHS to the particular user at a privilege level dependent on the determined location information for the particular user.

In yet another embodiment, a computer program product is disclosed that includes a computer readable storage medium. The computer program product includes first program instructions to store security information that associates a role with a particular user, the role designating a privilege level for the particular user that is dependent on a network login location from which the particular user attempts to login to an IHS. The computer program product also includes second program instructions to determine the particular network login location from which the particular user attempts to login to the IHS, thus providing determined location information. The computer program product further includes third program instructions to grant access to the IHS to the particular user at a privilege level dependent on the determined location information for the particular user.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 depicts a block diagram of one embodiment of the disclosed network system with security management capabilities.

FIG. 2 shows a block diagram of one embodiment of the disclosed information handling system (IHS) with security management capabilities.

FIG. 3 is flowchart that depicts process flow when the operating system of the IHS practices the disclosed security management method.

### DETAILED DESCRIPTION

In one embodiment, a network system includes multiple information handling systems (IHSs) that employ a security management system. The security management system controls the authorization of user or client actions across the network system. The network system, such as a lightweight directory access protocol (LDAP) or other system, may require security authorization on a per user basis for user access and rights. An IHS of the network system, such as an LDAP security server, client system, host, or other IHS includes a database of information. The database may include data that describes the capability of the user to access information and may also include user roles. A user role provides restrictive user access to network system services during execution of a security management method by the security server. For example, in a network system using protocol methods, such as LDAP, a user may interrogate the network system for particular data using specific criteria, such as a name or other data match. The network system may restrict the user to a limited portion of the entire data of the network system using LDAP or other protocol methods.

A network system may include directory information such as a database of telephone numbers, address information, and other information with attributes in a logical and hierarchical order. For example, a network system may include a security server with a telephone directory that includes an employee name list in alphabetical order with each name having a respective address, telephone number and other employee related information. In the disclosed network system, a security management method and tool provides a level of restrictive control over user actions. For example, a particular user may login to the network system and request a particular operation. The network system monitors each user login and operation request and may authorize or restrict that operation on a per user and per operation basis. In one embodiment, the network system restricts a particular user's operations and access to information in the database dependent on where that particular user's login occurs in the network system. For example, the network system may grant the user a particular level of access to information if the user logs in from location A, but the network system may grant the user a lower or higher amount of access to information if the user logs in from location B.

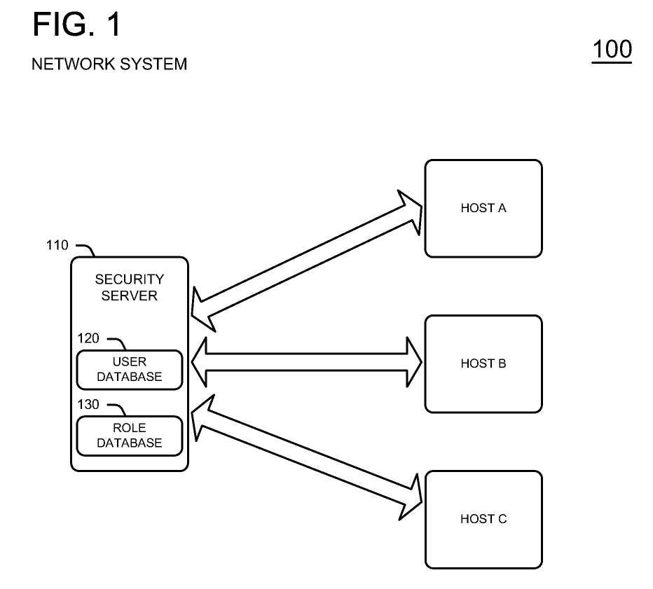

FIG. 1 shows a network system 100 that is configured to practice the disclosed security management methodology. Network system 100 includes a security server 110. Security server 110 may be an LDAP server, a directory service agent (DSA), or other IHS. Security server 110 includes a user database 120. User database 120 may include an index information store, such as a telephone directory, list of names, organizational data, or other information. Security server 110 includes a role database 130 that stores security information for users of network system 100. Network system 100 includes multiple host IHSs, namely host A, host B, and host C that each communicate with security server 110. In one embodiment of the disclosed security management method, security server 110 employs user database 120 as a central database. In other words, security server 110 shares user database 120 information between host A, host B, host C, and security server 110.

Network system 100 stores security information such as user rights and privileges within role database 130. A network system administrator, super user, root authority, or other authority of network system 100 generates and maintains the security rights for each user. A user may have multiple roles that the network system administrator or other authority assigns. For example, as shown in role assignment Table 1 below, a particular user1 may have three role assignments. In one embodiment, role database 130 stores Table 1 that includes these role assignments that associate with user1. Network system 100 stores a “role1” user attribute assignment in role database 130 that allows a “user add privilege” for the user1 when logging in from host A. Network system 100 also stores a “role2” assignment in role database 130 that allows a “user modify privilege” for the user1 when logging in from host A, or host B. Network system 100 also stores a “role3” assignment in role database 130 that allows a “user delete privilege” for the user1 when logging in from host C. The first column of Table 1 lists the particular user that this table associates with roles and user privileges based upon login location (i.e. login at host A, host B or host C).

As seen below, role assignment Table 1 associates user1 with roles and user privileges based upon login location. The second column in Table 1 defines the role number for a particular user such as user1. The third column in Table 1 defines the task privilege level for that particular role and user. The fourth column defines the restrictive login information, such as an allowed hostname or IP address of network system 100. The Login location information may include multiple IP addresses or hostnames for the user's role and task privilege level. In actual practice, Table 1 may include more task privilege levels than shown, depending on the particular application. In this role assignment Table 1, user 1 has 3 roles.

TABLE 1
user1

| | ROLE | PRIVILEGE LEVEL | LOGIN LOCATION |
|---|---|---|---|
| user1 | role1 | user add privilege | host A |
| user1 | role2 | user modify privilege | host A, host B |
| user1 | role3 | user delete privilege | host C |

As shown in Table 1 above, network system 100 stores or maintains a particular grouping of user roles for a particular user, namely user1. The user roles define a set of restrictions, authorities, rights, or privileges that depend upon the originating login location (or hostname) within network system 100. For example, user1 may have user add privileges when logging into host A, but no such privileges when logging into host B or host C, as role1 of Table 1 defines. Role2 provides user1 with user modify privileges when logging in from host A or host B, but no such privileges when logging into host C. Role3 provides user1 with delete user privileges within security server 110 or other location of network system 100, when logging in from host C, but no such privileges when logging into host A, or host B or any other host not shown in FIG. 1. Network system 100 may store similar security roles, tasks and login location data for multiple users in role database 130.

For example, role database 130 may also store a role assignment Table 2 for a particular user2, as seen below:

TABLE 2
user2

| | ROLE | PRIVILEGE LEVEL | LOGIN LOCATION |
|---|---|---|---|
| user2 | role1 | user add privilege | host B |
| user2 | role2 | user modify privilege | host A, host C |
| user2 | role3 | user delete privilege | |
| user2 | role4 | password set privilege | host A |

As shown in Table 2 above, network system 100 stores or maintains a particular grouping of user roles for a particular user, namely user2. The user roles define a set of restrictions, authorities, rights, or privileges that depend upon the originating login location (or hostname) within network system 100. For example, user2 may have user add privileges when logging into host B, but no such privileges when logging into host A or host C, as role1 of Table 2 defines. Role2 provides user2 with user modify privileges when logging in from host A or host C, but no such privileges when logging into host B. In one embodiment, network system 100 defines an empty or lack of hostname data as permission for a particular user and role for all login locations. For example, role3 provides user2 with delete user privileges within security server 110 or other location of network system 100, when logging in from any host. Role2 provides user2 with user password set privileges when logging in from host A, but no such privileges when logging into host B, or host C. Network system 100 may store similar security roles, tasks and login location data for multiple users in role database 130.

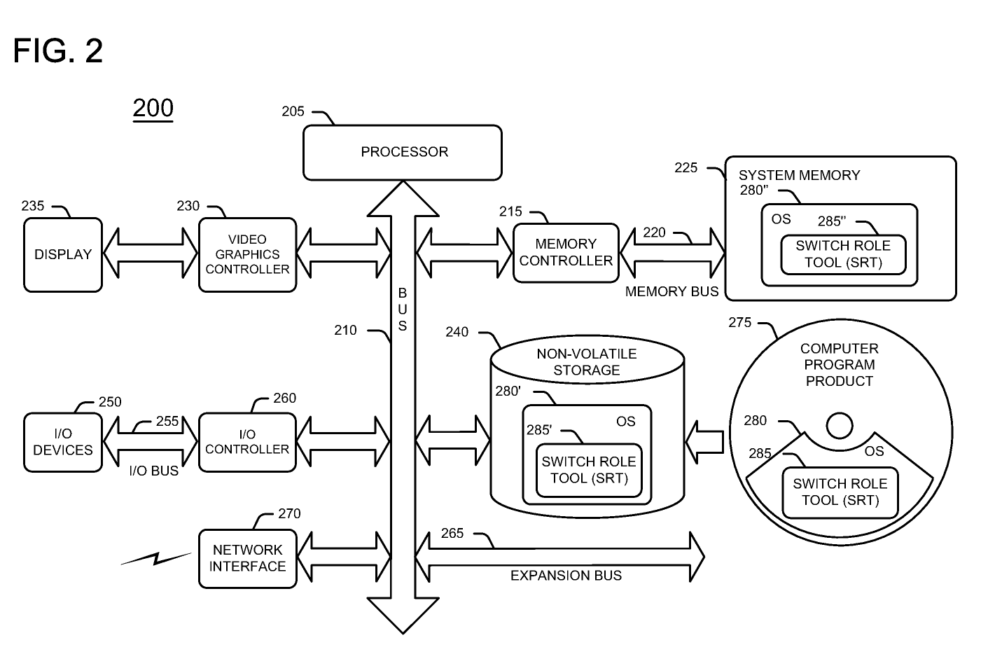

FIG. 2 shows an information handling system (IHS) 200 that is configured to practice the disclosed security management methodology. IHS 200 includes a processor 205 that may include multiple cores. IHS 200 processes, transfers, communicates, modifies, stores or otherwise handles information in digital form, analog form or other form. IHS 200 includes a bus 210 that couples processor 205 to system memory 225 via a memory controller 215 and memory bus 220. In one embodiment, system memory 225 is external to processor 205. System memory 225 may be a static random access memory (SRAM) array or a dynamic random access memory (DRAM) array. A video graphics controller 230 couples display 235 to bus 210. Nonvolatile storage 240, such as a hard disk drive, CD drive, DVD drive, or other nonvolatile storage couples to bus 210 to provide IHS 200 with permanent storage of information. I/O devices 250, such as a keyboard and a mouse pointing device, couple to bus 210 via I/O controller 260 and I/O bus 255.

One or more expansion busses 265, such as USB, IEEE 1394 bus, ATA, SATA, PCI, PCIE and other busses, couple to bus 210 to facilitate the connection of peripherals and devices to IHS 200. A network interface adapter 270 couples to bus 210 to enable IHS 200 to connect by wire or wirelessly to a network and other information handling systems. While FIG. 1 shows one IHS that employs processor 205, the IHS may take many forms. For example, IHS 200 may take the form of a desktop, client, server, portable, laptop, notebook, or other form factor computer or data processing system. IHS 200 may take other form factors such as a gaming device, a personal digital assistant (PDA), a portable telephone device, a communication device or other devices that include a processor and memory.

IHS 200 includes a computer program product on digital media 275 such as a CD, DVD or other media. In one embodiment, digital media 275 includes an operating system OS 280 that employs a switch role tool (SRT) 285 that is configured to practice the disclosed security management methodology. OS 280 employs SRT 285 as a software or application program during OS 280 execution. For example, a user may login using a switch role command that SRT 285 interprets to provide the restrictive privileges for that user dependent upon login location, such as shown in Table 1 above. In practice, IHS 200 may store operating system OS 280 on nonvolatile storage 240 as operating system OS 280′ and further store SRT 285 on nonvolatile storage 240 as SRT 285′. When IHS 200 initializes, the IHS loads operating system OS 280′ into system memory 225 for execution as operating system OS 280″. Operating system OS 280′ loads in memory 225 to govern the operation of IHS 200. IHS 200 also loads SRT 285′ into system memory 225 as application 285″.

A network system user, client, or other user entity may login to a particular IHS of network system 100, such as host A. For example, a user may issue a command that includes a search to retrieve directory information from user database 120. Other examples of user commands of network system 100 include add new entry to user database 120, delete entry of user database 120, modify a user database 120 entry and other database commands. The user may request to remove a user from network system 100, shut down a particular server, such as security server 110, and other security sensitive commands. The switch role tool SRT 285 provides network system 100 with enhanced security management capability. For example, SRT 285 provides the ability to determine which host, hostname, or login location of network system 100 that a particular user logs in from.

As stated above, SRT 285 provides a method to generate restrictive privileges dependent upon the user name and the particular associated hostname, such as host A from which the user logs in. For example, a particular user may log into host A and issue a command to modify a particular entry of user database 120. SRT 285 provides a network system administrator, super user or other authority the ability to restrict that command to host A only. For example, if the same user logs into host C and issues an identical command to modify that particular entry of user database 120, SRT enables network system 200 to reject or deny that command on the basis of that particular hostname from which the login occurs.

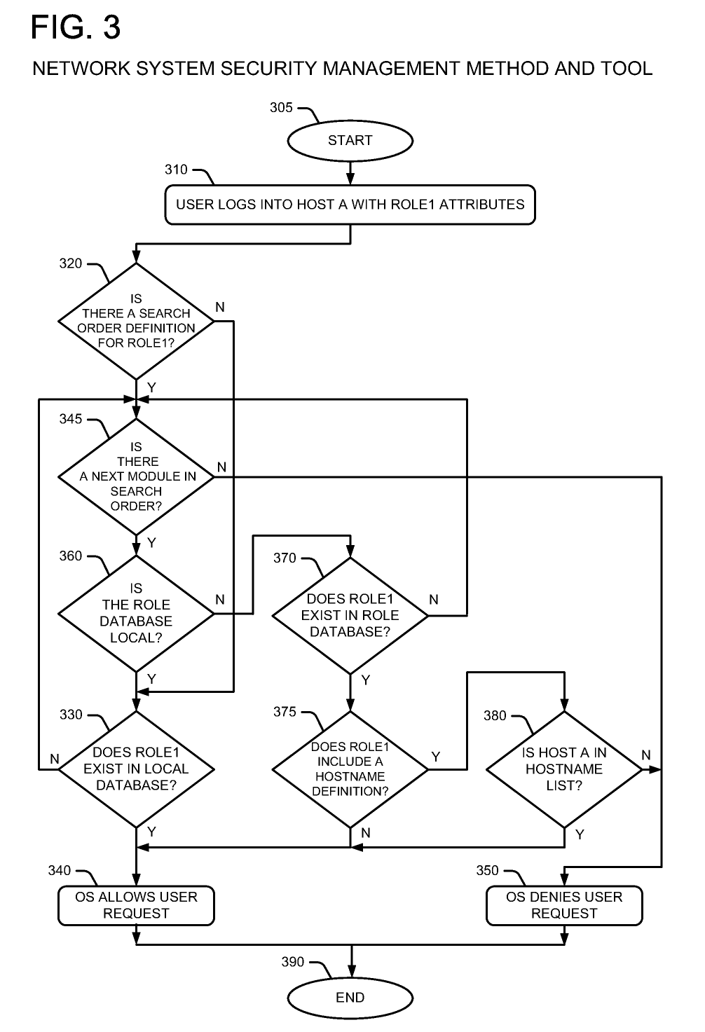

FIG. 3 is a flowchart that shows process flow in a representative network system 100 that is configured to implement the disclosed security management methodology. The network system security management method starts, as per block 305. A user logs into host A with role1 attributes, as per block 310. OS 280 employing switch role tool (SRT) 285 responds to a switch role command, such as that of a user login into a network system 100 that may employ a lightweight directory access protocol (LDAP). In one embodiment of the disclosed security management method, the user login includes a role1 attribute, as shown in Table 1 above, that network system 100 supports using LDAP or other protocols. For example, a switch role1 command provides the user with a restrictive user add privilege when logging into host A only, as shown in Table 1 above.

OS 280 performs a test to determine if there is a search order definition for roles, as per block 320. For example, OS 280 utilizing SRT 285 performs a test to determine if role database 130 includes search order definitions in role database 130. The user may use a switch role command to perform the login to host A. The user may login with a user name and a user password. Role database 130 may include search order definitions (not shown) that provide OS 280 or other software search criteria to support user login requests. OS 280 identifies the login request and determines the login location or hostname as host A by use of a network system 100 IP address or other addressing mechanism. If host A does not have search order definitions for roles, OS 280 performs a test to determine if role1 data exists in a local database, as per block 330. If OS 280 locates role1 from local data case, OS 280 allows the user request, as per block 340.

If OS 280 determines that role1 user attributes do not exist in a local database, or if there is a particular search order definition for role1, OS 280 performs a test to determine if there is a next module in the particular search order, as per block 345. In other words, OS 280 interrogates other locations of network system 100 for role1, such as that shown in Table 1 above. If there is no next module found, OS 280 denies the user request, as per block 350. However, if there is a next module in the search order, OS 280 performs a test to determine if that module is local, as per block 360. If that module data is local, OS 280 again performs a test to determine if role1 user attributes exist in a local database and testing continues, as per block 330. However, if the module is not local, OS 280 performs a test to determine if role1 information exists in role database 130, as per block 370.

If operating system OS 280 determines that role1 does not exist in a local database, then OS 280 tests to determine if there is a next module and flow continues, as per block 345. If role1 exists in the module, such as role database 130, OS 280 performs a test to determine if role1 includes a hostname definition, as per block 375. For example, as shown in Table 1 above, role1 includes hostname definition data of host A. If role1 does not include hostname definition data, OS 280 interprets the lack of hostname data as permission to allow that role1 on any host, and OS 280 allows the user request, as per block 340. In other words, in one embodiment, if the hostname definition or login location attribute for a particular role is absent, OS 280 may interpret that lack of information as equivalent to all host access or privilege for the particular role. If role1 does include hostname definitions, such as that shown above in Table 1, OS 280 performs a test to determine if host A is in the hostname list, as per block 380. If host A is in the hostname list, such as the user role attribute data of Table 1 above, OS 280 allows the user request, as per block 340. However if host A is not in the hostname list, OS 280 denies the user request, as per block 350. The security management process ends, as per block 390.

In one embodiment, network system 100 may use the switch role tool SRT 285 of OS 280 to activate multiple roles for a particular user simultaneously. For example, one switch role command may include role definitions for the user such as role1, role2, and role3 as shown in Table 1 above. In another embodiment of the disclosed security management method, SRT 285 may activate 8 roles for a particular user simultaneously. OS 280 may provide user role attributes for a particular user on a per host basis that may include other hosts not shown in FIG. 1 above. In other embodiments of the disclose security management method, network system 100 may include user database 120 and role database 130 information in a central location, such as security server 110. In other embodiments, network system 100 may store database information (not shown) in other local or remote servers or other locations of network system 100.

As will be appreciated by one skilled in the art, aspects of the disclosed security management technology may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
storing, by a first information handing system (IHS), security, information that associates a role with a particular user, the role designating a privilege level for the particular user that is dependent on a network login location from which the particular user attempts to login to the first IHS;
determining, by the first IHS, the particular network login location from which the particular user attempts to login to the first IHS, thus providing determined location information; and
granting, by the first IHS, access to the first IHS to the particular user at a privilege level dependent on the determined location information for the particular user.

2. The method of claim 1, further comprising storing, by the first IHS, multiple roles for a particular user, each role corresponding to a different privilege level dependent on a respective different network login location.

3. The method of claim 1, wherein the granting, by the first IHS, access to the first IHS includes granting access to a database in the first IHS.

4. The method of claim 1, wherein the security information includes username, respective role, respective privilege level attribute and respective login location attribute.

5. The method of claim 4, further comprising granting, by the first IHS, all access privilege levels to the first IHS if the login location attribute is absent in a login request.

6. The method of claim 1, wherein the storing step comprises storing, by the IHS, security information for multiple users, the security information for each user designating different privilege levels dependent on the network login location for each user.

7. The method of claim 1, wherein the storing step comprising storing the security information in a role assignment table.

8. An information handling system (IHS), comprising:
a processor,
a memory, coupled to the processor, the memory being configured to:
store security information that associates a role with a particular user, the role designating a privilege level for the particular user that is dependent on a network login location from which the particular user attempts to login to the IHS;
determine the particular network login location from which the particular user attempts to login to the IHS, thus providing determined location information; and
grant access to the IHS to the particular user at a privilege level dependent on the determined location information for the particular user.

9. The IHS of claim 8, wherein the memory is configured to store multiple roles for a particular user, each role corresponding to a different privilege level dependent on a respective different network login location.

10. The IHS of claim 8, wherein the IHS grants access to a database in the IHS when the IHS grants access to the IHS to a particular user.

11. The IHS of claim 8, wherein the security information includes username, respective role, respective privilege level attribute and respective login location attribute.

12. The IHS of claim 11, wherein the IHS grants all access privilege levels to the IHS if the login location attribute is absent in a login request.

13. The IHS of claim 8, wherein the security information includes security information for multiple users, the security information for each user designating different privilege levels dependent on the network login location for each user.

14. The IHS of claim 8, wherein the IHS includes a role assignment table that stores the security information.

15. A computer program product, comprising:
a computer readable storage medium;
first program instructions to store security information that associates a role with a particular user, the role designating a privilege level for the particular user that is dependent on a network login location from which the particular user attempts to login to an IHS;
second program instructions to determine the particular network login location from which the particular user attempts to login to the IHS, thus providing determined location information; and
third program instructions to grant access to the IHS to the particular user at a privilege level dependent on the determined location information for the particular user.

16. The computer program product of claim 15, further comprising fourth instructions to store multiple roles for a particular user, each role corresponding to a different privilege level dependent on a respective different network login location.

17. The computer program product of claim 15, further comprising fifth instruction's to grants access to a database in the IHS when the IHS grants access to the IHS to a particular user.

18. The computer program product of claim 15, wherein the security information includes username, respective role, respective privilege level attribute and respective login location attribute.

19. The computer program product of claim 18, further comprising sixth instructions to grants all access privilege levels to the IHS if the login location attribute is absent in a login request.

20. The computer program product of claim 15, wherein the security information includes security information for multiple users, the security information for each user designating different privilege levels dependent on the network login location for each user.
